(19) United States
(12) Patent Application Publication
(10) Pub. No.: US 2013/0000299 A1
(43) Pub. Date: Jan. 3, 2013

(54) HEAT SHIELD APPARATUS

(75) Inventor: Manoj Kumar Bada Ghar Wala, Montgomery, IL (US)

(73) Assignee: Caterpillar Inc., Peoria, IL (US)

(21) Appl. No.: 13/173,256

(22) Filed: Jun. 30, 2011

(51) Int. Cl. F02B 33/40; F02B 77/11

(52) U.S. Cl. 60/605.1

(57) ABSTRACT

The present disclosure relates to a heat shield apparatus for an engine. The apparatus includes an exhaust manifold enclosing section, a turbo enclosing section and at least one cooling source. The exhaust manifold enclosing section forms a first passage around an exhaust manifold. Furthermore, the turbo enclosing section forms a second passage around a turbo charging unit. Moreover, the first passage and the second passage a fluidly connected. In addition, the at least one cooling source is configured to produce a flow of cooling fluid in the first passage and/or the second passage.

### TECHNICAL FIELD

The present disclosure relates to a heat shield apparatus for a turbo charging unit and exhaust manifold of a vehicle. More specifically, the present disclosure relates to a heat shield apparatus for a turbo charging unit and exhaust manifold for landfill compactors and machines working in similar environments.

### BACKGROUND

During operation, the engine of a vehicle can reach very high temperatures. The exposed region of the engine, specifically the exhaust gas manifold and the turbo charging unit, are some of the very highest temperature zones associated with the engine. The high temperatures are typically due to the flow of hot exhaust gases through these components. Excessive temperatures in these zones can lead to various thermal issues, such as failure in material capability of turbo charging unit/exhaust gas manifold, and failure of seals and other components due to extreme under hood temperature. Also, in certain environments where there is an excessive amount of flammable debris, such in the case of landfill operations, combustion of materials that comes into these zones or contacts high temperature components present a hazardous and damaging condition.

Various previously proposed solutions have been used to keep the engine exhaust manifold and turbo charging at a lower temperature. One of the existing methods is to use material that can withstand high temperatures for construction of the turbo charging unit and exhaust manifold. In another method, soft wraps have been used; however the soft wraps may fail in early hours of their usage. In yet another existing method, thermal shields in form of heat insulation layers are attached around the engine components. However, such arrangement leads to trapping of heat within engine compartment, thereby increasing the under hood temperature, which may cause other problems, and does not adequately address the issue of combustible debris.

While various methods and designs have been developed to decrease the temperature of under hood components, there is still room for further contributions to the technology area.

### SUMMARY

One objective of the present disclosure is to provide an effective and easy to assemble heat shield apparatus for an exhaust manifold and turbo charging unit of an industrial machine, such as a landfill compactor, wheel or tracked loader, bulldozer or the like.

In an embodiment of the present disclosure, the heat shield apparatus for an engine in provided. The heat shield apparatus includes an exhaust manifold enclosing section. The exhaust manifold enclosing section forms a first passage around an exhaust manifold of the engine. Further the heat shield apparatus includes a turbo enclosing section. The turbo enclosing section forms a second passage around a turbo charging unit. Furthermore, the turbo enclosing section is coupled to the exhaust manifold enclosing section.

Moreover, the heat shield apparatus comprises at least one cooling source configured to produce a flow of cooling fluid in the first passage and the second passage.

In an embodiment of the present disclosure, a machine is provided. The machine includes an engine block having engine components. Further the machine includes an exhaust manifold attached to the engine block for carrying engine exhaust gas. Furthermore, the machine includes a turbo charging unit attached to the engine block for turbo charging intake air. Moreover, the machine includes an exhaust manifold enclosing section. The exhaust manifold enclosing section, forms a first passage around the exhaust manifold. Furthermore, the machine includes a turbo enclosing section. The turbo enclosing section forms a second passage around the turbo charging unit. Further, the machine comprises at least one cooling source configured to produce a flow of cooling fluid through the first passage and the second passage.

In yet another embodiment, the heat shield apparatus includes an exhaust manifold enclosing section. The exhaust manifold enclosing section comprising a first plurality of sections. The first plurality of sections is assembled to form a first passage around an exhaust manifold. Furthermore, heat shield apparatus includes a turbo enclosing section. The turbo enclosing section includes a second plurality of sections assembled to form a second passage around a turbo charging unit. Furthermore, the heat shield apparatus includes at least one cooling source configured to produce a flow of cooling fluid through the first passage and the second passage.

### BRIEF DESCRIPTION OF THE DRAWINGS

The accompanying drawings, where like reference numerals refer to identical or functionally similar elements throughout the separate views, and which, together with the detailed description below, are incorporated in and form part of the specification, serve to further illustrate various embodiments and explain various principles and advantages, all in accordance with the present disclosure.

FIG. 1 is a perspective view of an exemplary machine, a landfill compactor, in accordance with an embodiment of the present disclosure;

FIG. 2 is a perspective view of a heat shield apparatus, in accordance with an embodiment of the present disclosure;

FIG. 3 is a partially exploded view of the heat shield apparatus of FIG. 2, in accordance with an embodiment of the present disclosure;

FIG. 4 is a bottom perspective view of the heat shield apparatus of FIG. 2, in accordance with an embodiment of the present disclosure; and

FIG. 5 is a perspective view illustrating a heat shield apparatus mounted on an engine in accordance with an embodiment of the present disclosure.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present disclosure.

### DETAILED DESCRIPTION

Before describing the embodiments in detail in accordance with the present disclosure, it should be observed that these embodiments reside primarily in a heat shield apparatus and a machine. Accordingly, the system components have been represented to show only those specific details that are pertinent for an understanding of the embodiments of the present disclosure, and not the details that will be apparent to those with an ordinary skill in the art.

In this document, the terms “comprises,” “comprising,” or any other variation thereof, are intended to cover a non-exclusive inclusion, such that a process, method, article or apparatus that comprises a list of elements does not include only those elements but may include other elements not expressly listed or inherent to such a process, method, article or apparatus. An element proceeded by “comprises . . . a” does not, without more constraints, preclude the existence of additional identical elements in the process, method, article or apparatus that include the element. The term “another,” as used in this document, is defined as “at least two or more”. The term “includes”, as used herein, is defined as comprising. Further, the terms “coupling”, “coupled”, “attaching” or “attached” or any other variation therefore are used interchangeably in this document and refers to same meaning and scope.

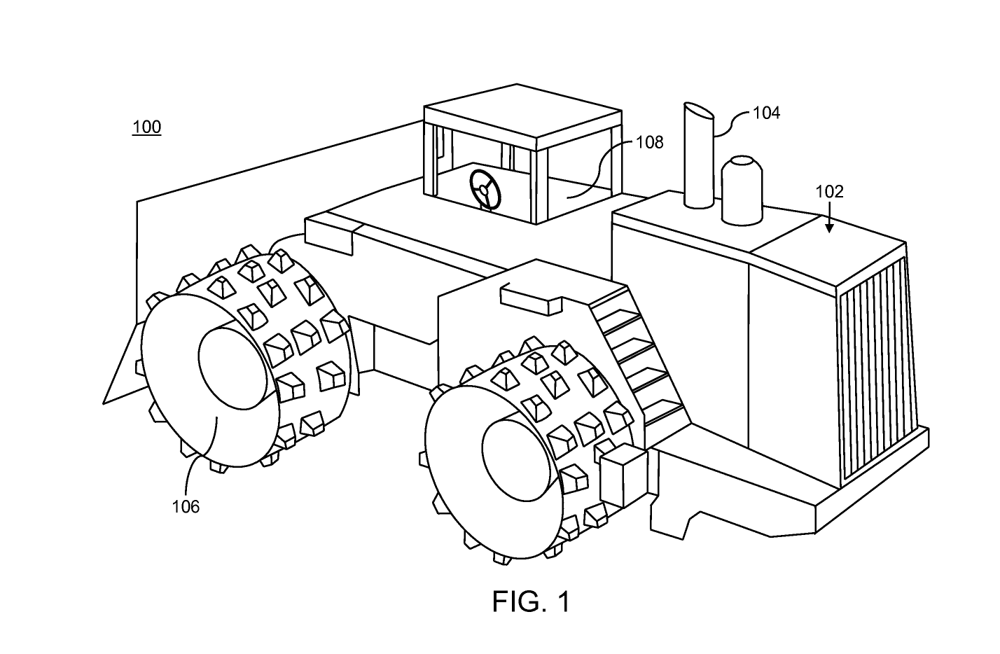

FIG. 1 is a perspective view of an exemplary machine 100, in accordance with an embodiment of the present disclosure.

The machine 100, specifically a landfill compactor 100, comprises an engine compartment 102, an exhaust stack 104, compacting wheels 106, and operator cabin 108. In an embodiment, the machine 100 can be a heavy earth moving vehicle such as an excavator, a wheel loader, a track type tractor etc. In particular, the disclosed heat shields are useful in landfill operations where the environment may include a large amount of flammable debris. Typical machines that operate in such environments are landfill compactors, wheeled and track type loaders, wheeled and track type tractors (bulldozers), material handlers, excavators and the like. The landfill compactor 100 is designed to work in the waste management industry for spreading and compacting refuse. In general, the landfill compactor 100 derives its power from an engine, placed inside the engine compartment 102. The exhaust of the engine is passed out in the atmosphere thorough the exhaust stack 104. The landfill compactor 100 has specially designed compacting wheels 106 to shred and press together the waste, so as to consume minimal space in the landfill. The landfill compactor 100 is controlled by an operator in the operator cabin 108. The operator cabin 108 typically includes the mechanisms and operation panels for primary control of the landfill compactor 100 such as steering, propulsion, condition monitoring, positioning, communications, etc.

The landfill compactor 100 works in harsh environment where the waste and refuse material is compacted. The engine and the attached components of the landfill compactor 100 are secured and protected in the engine compartment 102.

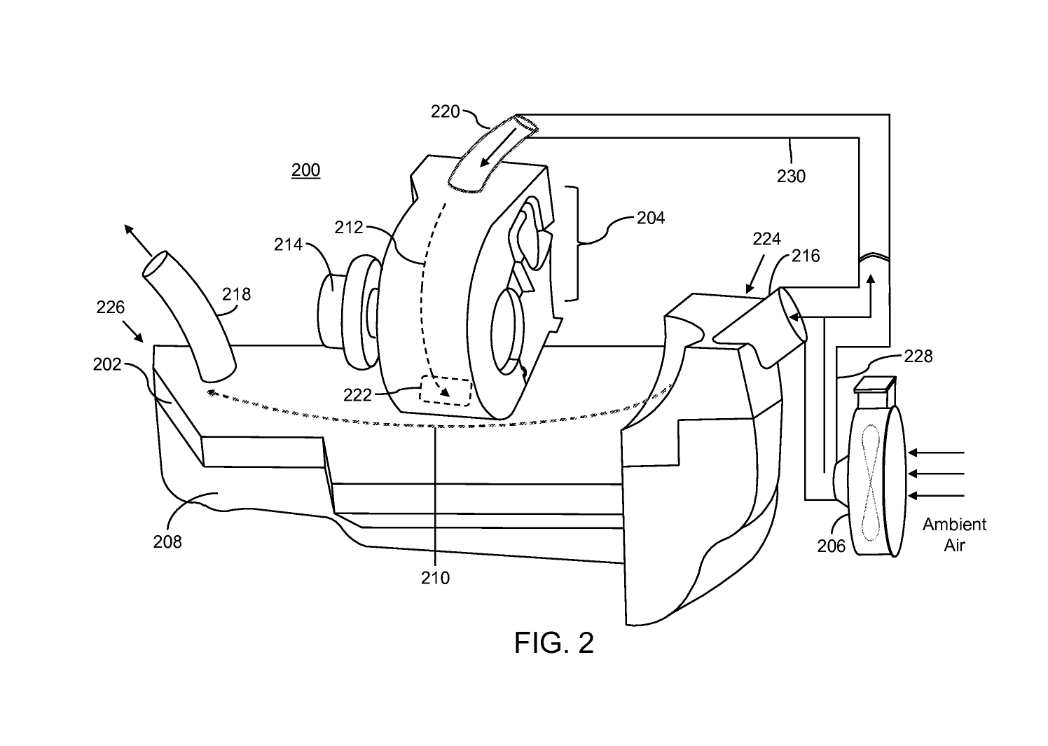

FIG. 2 is a perspective view of a heat shield apparatus 200, in accordance with an embodiment of the present disclosure.

The heat shield apparatus 200 includes an exhaust manifold enclosing section 202, a turbo enclosing section 204 and at least one cooling source 206.

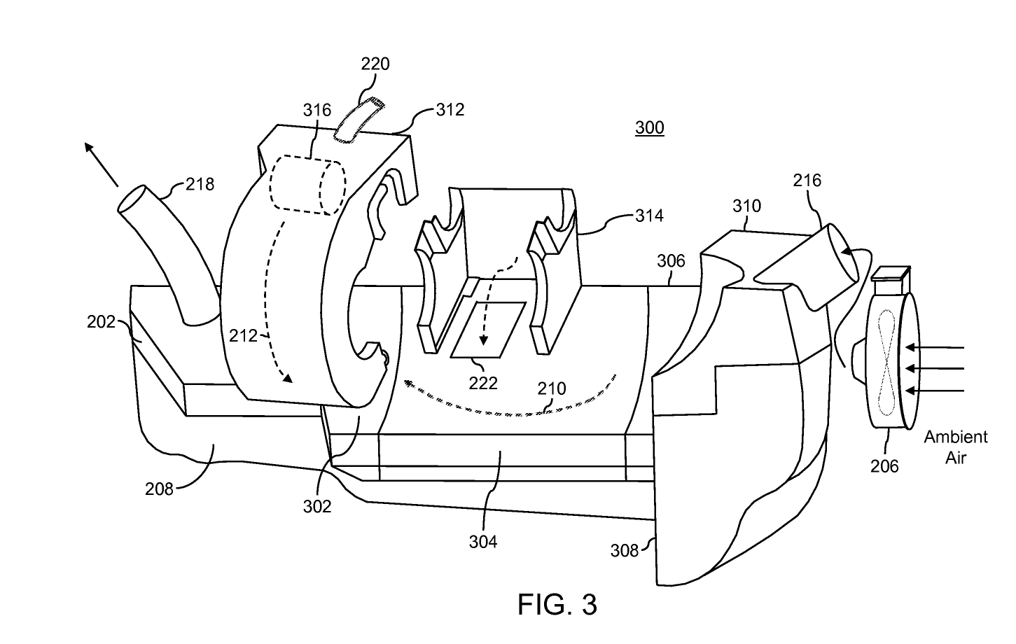

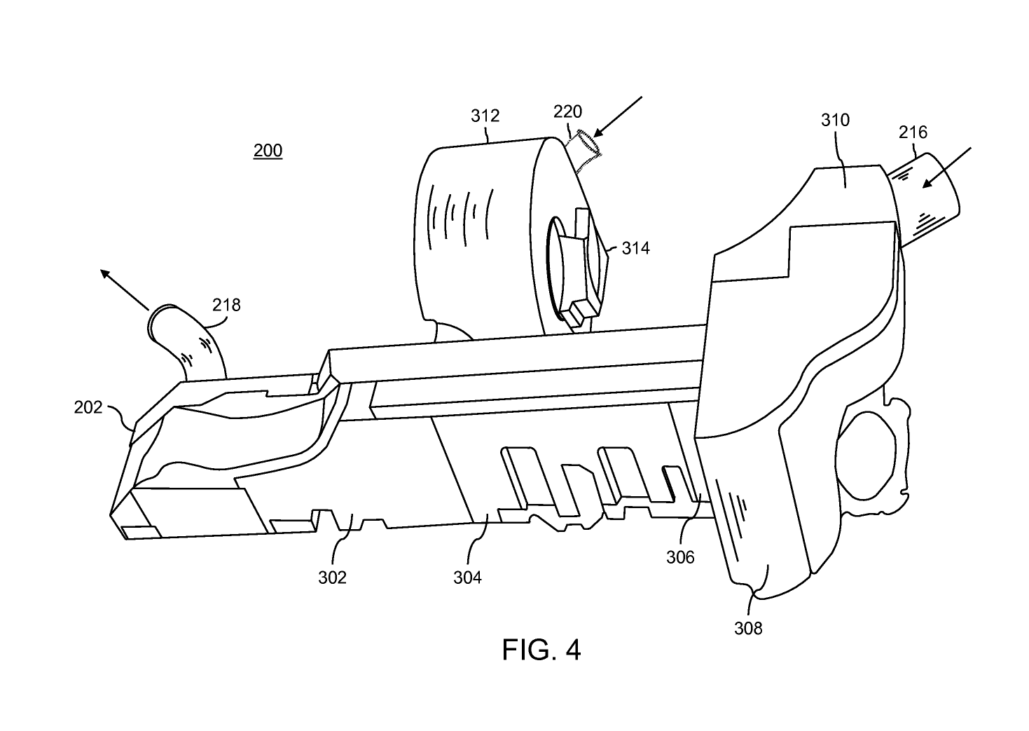

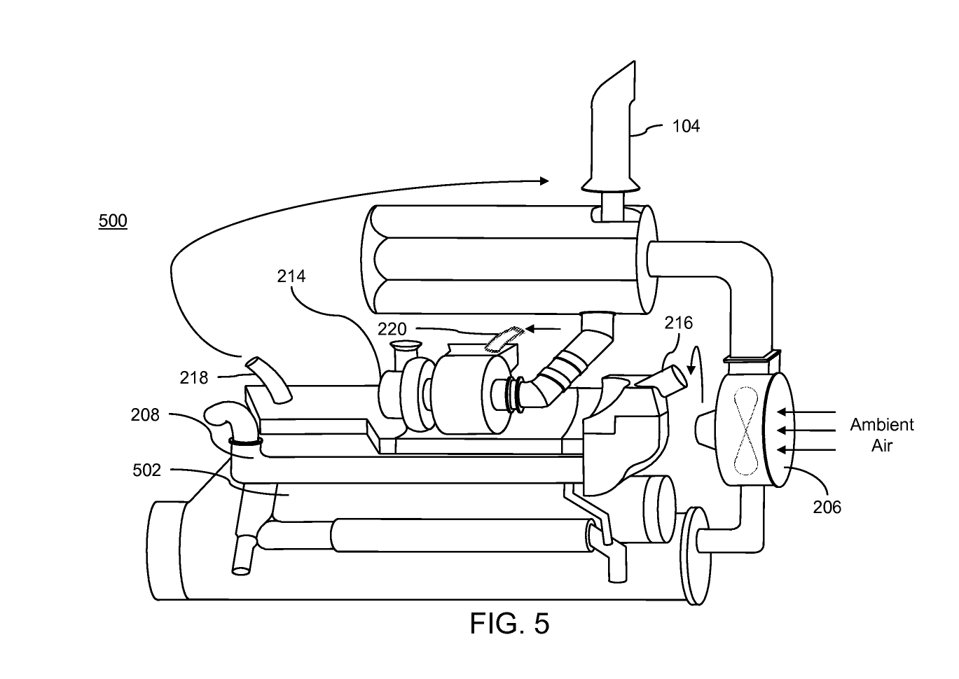

The exhaust manifold enclosing section 202 encloses an exhaust manifold 208 of an engine (as further shown in FIG. 5). The exhaust manifold enclosing section 202 includes a first plurality of sections 302-310 (as shown in FIG. 3 and FIG. 4) that are assembled to form a first passage 210 between the exhaust manifold enclosing section 202 and the exhaust manifold 208. In other words, the sections 302-310 are assembled with each other and with the exhaust manifold 208 through, for example, a plurality of fasteners (not shown) to form the first passage 210. The first passage 210 is a hollow channel formed around the exhaust manifold 208. In order to develop further understanding, consider multiple sections, each section designed to fit around the exhaust manifold 208. The multiple sections are assembled to form a continuous first passage 210 around the exhaust manifold 208. The multiple sections can be secured, such as press or snap fitted, with one another and can be assembled on the exhaust manifold with the help of fastener such as screw arrangement.

In a similar manner, the turbo enclosing section 204 may include a second plurality of sections 312 and 314 (as shown in FIG. 3 and FIG. 4) that are assembled to form a second passage 212. In other words, the sections 312 and 314 are assembled with each other and on the turbo charging unit 214, for example through one or more fasteners (not shown) to form the second passage 212 around the turbo charging unit 214. The second passage 212 is formed around the turbo charging unit 214. The first plurality of sections 302-310 and the second plurality of sections 312-314 are further detailed in conjunction with FIG. 3.

Further, the first passage 210 includes at least one first inlet 216 and at least one first outlet 218. The first inlet 216 and the first outlet 218 are located at a first end 224 of the first passage 210 and a second end 226 of the first passage 210, respectively. Similarly, the second passage 212 includes at least one second inlet 220 and at least one second outlet 222.

It is to be noted that the first passage 210 and the second passage 212 are fluidly connected. In other words, the second outlet 222 of the second passage 212 is connected with the first passage 210. In an embodiment the second outlet 222 of the second passage 212 is connected with the first passage 210 at a position located between the first end 224 and the second end 226.

In an embodiment, the cooling source 206, is a centrifugal fan. It is to be noted that the cooling source 206 provides the flow of cooling air to the first passage 210 and the second passage 212. The cooling air is directed through a pair of ducts 228 and 230. The duct 228 directs the cooling air from the cooling source 206 to the first inlet 216. Similarly, the duct 230 directs the cooling air from the cooling source 206 to the second inlet 220. In another embodiment, the cooling source 206 is a blower.

The cooling source 206 is designed to blow air through the first passage 210 and the second passage 212. In other words, the draft of cooling air is from the centrifugal fan 206 is directed into the first passage 210 through the duct 228, and the second passage 212 through the duct 230. The cooling air entering the first inlet 216 passes through the first passage 210 and exits from the first outlet 218. Further, it is to be noted that the first passage 210 and the second passage 212 are fluidly connected. Hence, the cooling air entering the second passage 212 through the second inlet 220 is circulated through the second passage 212 and passed into the first passage through the second outlet 222.

In other words, cooling air from the cooling source 206 enters the first passage 210 and the second passage 212. Thereafter, the cooling air in the first passage 210 exists through the first outlet 218. And the air in the second passage 212 enters the first passage 210 through the second outlet 222 and exists along with the air in the first passage through the first outlet 218. In an embodiment, the first outlet 218 is connected to the exhaust stack 104 of the machine 100 and the hot air exiting the first outlet 218 is released in the environment through the exhaust stack 104.

FIG. 3 illustrates a partially exploded view of a heat shield apparatus 200, in accordance with an embodiment of the present disclosure.

The heat shield apparatus 200, in addition to the components shown if FIG. 2, is shown to include the first plurality of sections 302, 304, 306, 308 and 310. Further, the heat shield apparatus 200 is shown to include the second plurality of sections 312 and 314. It is to be noted that the number of sections are only for illustrative purposes, and various embodiments include suitable number of sections in the first plurality of sections and the second plurality of sections. The shield apparatus 200 is further shown to include a cooling source 316.

The first plurality of sections 302-310 is a set of multiple pieces that can be assembled together to form a continuous section. In one embodiment, each section of the first plurality of sections 302-310 is designed to be assembled around the exhaust manifold 208. In other words, the sections 302-310 are shaped to match with the shape of the exhaust manifold 208, such that the sections 302-310 fits around the exhaust manifold 208. In one embodiment of the present disclosure, the section 302 is also molded to include the first outlet 218. Similarly, the section 310 is molded to include the first inlet 216. In one embodiment, the cooling source 206 is centrifugal fan capable of drawing the ambient air and thereafter blowing the drawn air into the first passage 210 through the first inlet 216. In yet another embodiment, (as shown in FIG. 2), the cooling source 206 is configured to blow the drawn air in the second passage 212 through the second inlet 220. It is to be noted that a suitable arrangement of ducts, such as duct 228 and 230 can be designed to direct the cooling air from the cooling source 206 to the first inlet 216 and the second inlet 220.

The second plurality of sections 312 and 314 is a set of multiple pieces that can be assembled together to form a continuous second passage 212. In one embodiment, each section of the second plurality of sections 312-314 is designed to be assembled around the turbo charging unit 214. In other words, each section 312 and 314 is shaped to match with the shape of the turbo charging unit 214, such that each section fits around the turbo charging unit 214. In an embodiment of the present disclosure, the section 312 and 314 are snap fitted over each other to form a hollow casing around the turbo charging unit 214.

The second plurality of sections 312 and 314 are two sections that are assembled together to form the second passage 212 around the turbo charging unit 214. The section 312 of the second plurality of sections includes the second inlet 220 and houses the cooling source 316. In an embodiment, the cooling source 316 is a cooling fan. The cooling fan 316 is capable of pulling ambient air through the second inlet 220 and blowing it through the second passage 212. In one embodiment, the cooling source 316 is a hydraulic cooling fan. In yet another embodiment, the cooling source 316 is an electrically or pneumatically driven cooling fan.

Further, the section 314 includes the second outlet 222. The second outlet 222 is in form of an opening in the section 314. The second outlet 222 fluidly connects the second passage 212 with the first passage 210. In other words, the ambient air pulled in by the cooling source 316 is blown through the second passage 212 and further passed to the first passage 210 through the second outlet 222. The blown air is further, passed through the first passage 210 and exists through the first outlet 218.

The cooling source 206 provides cooling air into the first passage 210 and the cooling source 316 provides cooling air into the second passage 212. In this embodiment, the cooling source 316 draws in ambient air from the second inlet 220. Hence, the cooling source 316 provides cooling air into the second passage 212. The air circulated in the second passage 212 is passed into the first passage 210 through the second outlet 222. Thereafter, the cooling air from the second passage 212 and the cooling air in the first passage 210 exit through the first outlet 218. Further, the exited air through the outlet 218 is passed to the exhaust stack 104 through a suitable connection (not shown). In another embodiment, the exited air is directly exhausted to the atmosphere through the first outlet 218.

In an alternate embodiment, only the cooling source 206 is provided. The cooling source 206 provides cooling air into the first passage 210. In this embodiment, the cooling air from the first passage 210, enters the second passage through the second outlet 222 and exists from the second passage 212 through the second inlet 220. Thus in this embodiment, the fluid connection at the second outlet 222 between the first passage 210 and the second passage 212 acts as an air inlet for the second passage.

FIG. 4 is bottom perspective view of a heat shield apparatus 200, in accordance with an embodiment of the present disclosure. The heat shield apparatus 200 includes various sections of the first plurality of sections 302-310 and the second plurality of sections 312-314.

In an embodiment, the first plurality of sections 302-310 and the second plurality of sections 312-314 are molded to shape in accordance with the location where each part is to be assembled. In other words, the sections 302-310 are joined with each other and also fit at a specific location around the exhaust manifold 208. In one embodiment, the sections 302-310 are configured to slide between engine components to fit around the exhaust manifold 208. Such an arrangement enables the assembly of the plurality of sections to be assembled after the assembly of the engine. It is to be noted, that each section 302-310 is attached with each other through a suitable fastening mechanism such as a press fit connection, a snap fit connection and the like. Further, each section 302-310 is also assembled with the engine block 502 (as shown in FIG. 5) by a set of fasteners such as screw arrangement or any suitable permanent or temporary fastener. Similarly, the section 312 and 314 are also molded to match and fit at a specific location around the turbo charging unit 214.

FIG. 5 is a perspective view illustrating the heat shield apparatus 200 mounted on the engine 500, in accordance with an embodiment of the present disclosure.

In one embodiment, the engine 500 is an internal combustion engine of the machine 100 as described in FIG. 1. The engine 500 is shown to include an engine block 502. The engine block 502 includes various engine components such as combustion cylinders (not shown). Further, the machine 100 includes the exhaust manifold 208, and a turbo charging unit 214.

The exhaust manifold 208 and the turbo charging unit 214 are mounted on the engine block 502.

The exhaust manifold 208 is attached to engine block 502 for carrying away engine exhaust gases from the engine block 502. In other words, the exhaust gases from the combustion cylinders are exhausted out from the cylinders through the exhaust manifold 208. Further, the exhaust manifold 208 is shown to be enclosed by exhaust manifold enclosing section 202. The exhaust manifold enclosing section 202 is assembled around the exhaust manifold 208 to form a shield apparatus. In other words, the exhaust manifold enclosing section 202 are assembled to form a hollow passage around the exhaust manifold 208, thereby providing a shield around the exhaust manifold 208. Furthermore, the hollow passage is in form of a first passage 210. The first passage 210 is designed to allow flow of cooling air through it.

Similarly, the engine 500 of the machine 100 is shown to include a turbo charging unit 214. The turbo charging unit 214 is mounted on the engine block 502. The turbocharger unit 214 is configured for turbo charging the intake air into the combustion cylinder for increasing the efficiency of the engine 500. Further, the turbo charging unit 214 on the machine 100 is enveloped by the turbo enclosing section 204. The turbo enclosing section 204 forms a hollow covering around the turbo charging unit 214. The covering is in form to provide a second passage 212 around the turbo charging unit 214. In other words, the hollow covering forms a heat shield around the turbo charging unit 214 and also allows flow of cooling air through the second passage 212 thereby cooling the turbo charging unit 214.

The engine 500 is further shown to include a centrifugal fan 206. The centrifugal fan 206 is designed to force the ambient air to the first passage 210 and the second passage 212. In other words, air from the cooling fan 206 is directed into the opening 216 and 220 of the first passage and the second passage, respectively. Thus, the cooling air is blown through the first passage 210 and the second passage 212. It is to be noted that the centrifugal fan 206 is used as a cooling source and is only for exemplary purposes. In another embodiment, an independent cooling fan can also be provided for blowing the cooling air through the first passage 210 and the second passage 212. The independent cooling fan can be centrifugal fan driven by electrical, hydraulic, or pneumatic power.

Furthermore, the first passage 210 and the second passage 212 are fluidly connected through the second outlet 222 (as shown in FIG. 2 and FIG. 3). In one embodiment, the second outlet 222 is located between the first opening 216 and the first outlet 218.

Furthermore, the cooling air from the second outlet 222 is mixed with the cooling air flowing in the first passage 210. Thereafter, the cooling air from the first passage 210 and the second passage 212 is exited through the first outlet 218. In one embodiment, the cooling air is exited to the atmosphere. In another embodiment, the cooling air is exited to the atmosphere through the exhaust stack 104. It is to be noted that the first outlet 218 is connected with the exhaust stack 104 though a suitable connection (not shown).

To develop a better understanding consider the following scenarios, where the plurality of exhaust manifold enclosing section 202 and the turbo enclosing section 204 forms the first passage 210 and the second passage 212, respectively. In one embodiment, the cooling source 206 provides cooling air to the first passage 210 and the second passage 212 (as shown in FIG. 2). The cooling air circulating in the second passage 212 exits the second passage 212 through the second outlet 222. Further, the cooling air exiting the second passage 212 enters the first passage 210. Thereafter, the cooling air in the first passage 210 along with cooling air entered from the second passage 212 exits from first outlet 218.

In another embodiment, the cooling source 206 blows cooling air only into the first passage 210. Similarly, cooling source 316 blows in cooling air into the second passage 212. Thereafter, the cooling air from the second passage 212 exist the second passage 212 through the second outlet 222 and mixes with the cooling air in the first passage 210. Further, the cooling air in the first passage 210 along with the cooling air entering from the second outlet 222, exits through the first outlet 218.

In yet another embodiment, only one cooling source one cooling source 206 blows cooling air into the first passage 210. Thereafter, the cooling air in the first passage 210 circulates in the first passage 210 and enters second passage 212 through the second outlet 222. Further, the cooling air in the first passage 210 exits from the first outlet 218 and the cooling air in the second passage 212 exist to the atmosphere through the second inlet 220.

The above heat shield apparatus 200 provides an easy to assemble structure with improved cooling efficiency. The apparatus provides improved heat shielding as there is heat shield with a hollow passage for air flow. Further, cooling fluid such as cooling air is flown thorough hollow passage, thereby cooling the engine component and the heat shield. This improves the overall thermal efficacy since the continuous flow of cooling fluid improves heat exchange. Further, the heat shield apparatus 200 is in form of multiple sections that are designed to slide between the engine components. Furthermore, the sections are designed to be assembled on the engine after the engine has been assembled. Moreover, the flow of cooling air helps to reduce the under hood temperature. The above described apparatus also provides the possibility of having shielding apparatus for various engines and other similar applications.

In the foregoing specification, the disclosure and its benefits and advantages have been described with reference to specific embodiments. However, one of ordinary skill in the art would appreciate that various modifications and changes can be made without departing from the scope of the present disclosure, as set forth in the claims below. Accordingly, the specification and figures are to be regarded in an illustrative rather than a restrictive sense, and all such modifications are intended to be included within the scope of the present disclosure. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

### INDUSTRIAL APPLICABILITY

The heat shield apparatus 200 described above provides for effective heat shielding for engine components of an industrial machine. The heat shield apparatus 200 described above is designed to provide heat shield for engine component of a landfill compactor 100. The heat shield apparatus 200 includes an exhaust manifold enclosing section 202. The exhaust manifold enclosing section 202 is in form of multiple sections. Each section of the multiple sections is molded to match and fit at a specific location around the exhaust manifold 208. Thus, each section is assembled, around the exhaust manifold 208 and with each other, thereby forming a heat shield around the exhaust manifold 208. Further, the combined sections are assembled in a manner to form an envelope around the exhaust manifold 208 thereby forming the first passage 210 around the exhaust manifold 208.

Further, cooling fluid, such as air can pass through the first passage 210 to cool the exhaust manifold 208 and the manifold enclosing section 202. The cooling air can be blow by any suitable source of air such as a centrifugal fan 206. It may be noted that an additional fan may also provide for such purpose.

In a similar manner, a turbo enclosing section 204 is also provided to form a second passage 212 around the turbo charging unit 214.

Thus such as arrangement, provides for cooling the engine components, such as exhaust manifold 208 and the turbo charging unit 214 and also lowers the skin temperature of the multiple sections forming the heat shield around the exhaust manifold 208 and the turbo charging unit 214. Reduced skin temperature of the sections also alleviates the hazard of burning of combustible material falling on these sections. For example, for a landfill compactor 100, there is a high probability that the small bits of paper and other combustible waste material may fly and fall on the heat shields. Thus, lower skin temperature of the exhaust manifold enclosing section 202 and the turbo enclosing section 204 reduces the hazard of fire that may arise due to burning of the combustible waste material. Furthermore, lower skin temperature and a mechanism for blowing the cooling fluid to carrying away heat from the engine component also reduces the under hood temperature. This also increases the life of other components in the engine compartment 102.

Aspects of this disclosure may be applied to any combustion engine, specifically in industrial machines driven by engines. Aspects of this disclosure may also be applied to engines in machines such as land fill compactors, excavators, track type tractors, backhoe loaders, wheel loaders, pipe layers, and trucks. Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A heat shield apparatus for an engine, the apparatus comprising:
an exhaust manifold enclosing section, wherein the exhaust manifold enclosing section forms a first passage around an exhaust manifold;
a turbo enclosing section, wherein the turbo enclosing section forms a second passage around a turbo charging unit, and wherein the turbo enclosing section is coupled to the exhaust manifold enclosing section; and
at least one cooling source configured to produce a flow of cooling fluid in the first passage and the second passage.

2. The apparatus according to claim 1, wherein the first passage and the second passage are fluidly connected.

3. The apparatus according to claim 1, wherein the first passage has at least one first inlet and at least one first outlet and the second passage has at least one second inlet and at least one second outlet.

4. The apparatus according to claim 3, wherein the at least one cooling source is configured to produce flow of cooling fluid in the first passage and the second passage, through, the at least one first inlet located at a first end of the first passage and/or the at least one second inlet located at a first end of the second passage, and the at least one first outlet of the first passage located at a second end of the first passage.

5. The apparatus according to claim 4, wherein the at least one second outlet of the second passage is fluidly connected with the first passage.

6. The apparatus according to claim 4, wherein the turbo enclosing section is coupled to the exhaust manifold enclosing section and is located between the first end of the first passage and the second end of the first passage.

7. The apparatus according to claim 1, wherein the at least one cooling source is a centrifugal fan configured to produce a flow of cooling air through the first passage and/or the second passage.

8. The apparatus according to claim 1, wherein the at least one cooling source is a cooling fan located within the turbo enclosing section and is configured to produce a flow of cooling air through the first passage and the second passage.

9. The apparatus according to claim 1, wherein the exhaust manifold enclosing section comprises a first plurality of sections designed to assemble around the exhaust manifold to form the first passage and wherein the first plurality of sections are assembled with each other and the exhaust manifold through a set of fasteners.

10. The apparatus according to claim 1, wherein the turbo enclosing section comprises a second plurality of sections designed to assemble around the turbo charging unit to form the second passage, and wherein the second plurality of the sections are assembled with each other and the turbo charging unit through a set of fasteners.

11. A machine comprising:
an engine block having engine components;
an exhaust manifold attached to the engine block, for carrying engine exhaust gas;
a turbo charging unit attached to the engine block for turbo charging intake air;
an exhaust manifold enclosing section, wherein the exhaust manifold enclosing section forms a first passage around the exhaust manifold;
a turbo enclosing section, wherein the turbo enclosing section forms a second passage around the turbo charging unit, and wherein the turbo enclosing section is coupled to the exhaust manifold enclosing section; and
at least one cooling source configured to produce a flow of cooling fluid through the first passage and the second passage.

12. The machine according to claim 11, wherein the first passage and the second passage are fluidly connected.

13. The machine according to claim 11, wherein the first passage having at least one first inlet and at least one first outlet and the second passage having at least one second inlet and at least one second outlet.

14. The machine according to claim 13, wherein the at least one first inlet and the at least one second inlet are connect to the at least one cooling source through a set of ducts, and wherein the at least one cooling source is configured to receives ambient air.

15. The machine according to claim 13, wherein the at least one cooling source is configured to produce flow of cooling fluid in the first passage and the second passage, through, the at least one first inlet located at a first end of the first passage and/or the at least one second inlet located at a first end of the second passage, and the at least one first outlet of the first passage located at a second end of the first passage.

16. The machine according to claim 13, wherein the at least one outlet of the second passage is fluidly connected with the first passage.

17. The machine according to claim 11, wherein the at least one cooling source is a centrifugal fan configured to produce a flow of cooling air through the first passage and/or the second passage.

18. The machine according to claim 11, wherein the at least one cooling source is a cooling fan located within the turbo enclosing section and is configured to produce a flow of cooling air through the first passage and the second passage.

19. The machine according to claim 11, wherein the exhaust enclosing section comprises a first plurality of sections, assembled with each other and the engine block to form the first passage and wherein the first plurality of sections are designed to slide between the engine components.

20. The machine according to claim 11, wherein the turbo enclosing section comprises a second plurality of sections, assembled with each other and the engine block to form a second passage and wherein the second plurality of sections are designed to slide between the engine components.

21. A heat shield apparatus, the heat shield apparatus comprising:
an exhaust manifold enclosing section, wherein the exhaust manifold enclosing section comprising a first plurality of sections assembled to form a first passage around an exhaust manifold;
a turbo enclosing section, wherein the turbo enclosing section comprising a second plurality of sections assembled to form a second passage around a turbo charging unit; and
at least one cooling source configured to produce a flow of cooling fluid through the first passage and the second passage.

22. The apparatus according to claim 21, wherein the first passage and the second passage are being fluidly connected.

23. The machine according to claim 21, wherein the at least one cooling source is a cooling fan located within the turbo enclosing section and is configured to produce a flow of cooling air through the first passage and the second passage.
